(19) United States
(12) Patent Application Publication
(10) Pub. No.: US 2026/0356398 A1
(43) Pub. Date: Nov. 12, 2026

(54) ASSEMBLY COMPRISING A BOGIE FOR INSPECTION AND OR MAINTENANCE OF AN UNDERFRAME OF A RAILWAY CONVOY AND A GUIDE, AND METHOD THEREOF

(71) Applicant: Next Generation Robotics S.R.L., Pisa (IT)

(72) Inventors: Daniele Leonardis, Pisa (IT); Domenico Chiaradia, Pisa (IT); Luca Tiseni, Pisa (IT); Massimiliano Garbardi, Pisa (IT); Davide Garbin, Pisa (IT); Massimiliano Solazzi, Pisa (IT); Antonio Frisoli, Pisa (IT)

(73) Assignee: Next Generation Robotics S.R.L., Pisa (IT)

(21) Appl. No.: 19/488,765

(22) PCT Filed: May 31, 2024
(86) PCT No.: PCT/IB2024/055331

§ 371 Date: Nov. 28, 2025

(30) Foreign Application Priority Data
May 31, 2023 (IT) 102023000011082

(51) Int. Cl. B61F 13/00; B61D 15/12

(52) U.S. Cl. CPC B61F 13/00; B61D 15/12

(57) ABSTRACT

Assembly comprising a bogie (1) for inspection and/or maintenance of an underframe of a railway convoy, said bogie being of the type suitable for moving on a railway having two rails (R1, R2) placed side-by-side and a space(S) therebetween, said bogie comprising a frame (2); a plurality of wheel groups (31, 32, 33, 34), mounted to the frame and movable transversally between a retracted position in which they are out of contact with the respective rail and an extracted position in which they are in rolling contact with the respective rail; at least one transverse motion device (4) operatively connected with the wheel groups of said plurality for transversally moving in retraction and/or extraction the wheel groups of said plurality; one or more auxiliary bearings (7) for overcoming one or more obstacles present on at least one rail (R1, R2) of the railway. The assembly further comprises a rolling guide (8) for the auxiliary bearings (7) and an electronic control system (6).

### TECHNICAL FIELD

The object of the present invention is an assembly comprising a bogie for inspection and/or maintenance of an underframe of a railway convoy.

The bogie according to the invention is particularly suitable for overcoming obstacles present along the railway.

The assembly further comprises a rolling guide for the bogie.

The present invention also relates to a method for inspection and/or maintenance of an underframe of a railway convoy that which envisages overcoming of one or more obstacles on the railway.

### STATE OF THE ART

Bogies are generally known to move along railways to position themselves under a parked railway convoy in order to proceed with the inspection of the underframe of the railway convoy itself.

Such known bogies are typically provided with vertical-axis wheel groups to be able to roll on the inner stem or side of the rails, unlike what occurs with railway convoys that instead rest their conical wheels on the upper crown of the rail, i.e., the convex rolling surface facing upwards of the rail. This avoids the bogie having to proceed on the upper crown of the rail with the advantage of avoiding blockages due to the wheels of the railway convey itself.

For example, the prior art document WO-2018-060945 shows a railway vehicle solution for inspection of the underframe of railway convoys on the tracks having driving wheels with vertical axis to roll on the inner face of the rod or stem of the rails of the railway, and stabilization wheels with sub-horizontal axis resting on the lower fence plane of the rail. The driving wheels are elastically preloaded outwards, i.e., towards the rail stem by means of the provision of a transverse spring and a preload regulation device.

This type of railway vehicle, although satisfactory from some points of view, are not without any drawbacks.

In fact, where obstacles are present along the railway, and in particular obstacles present along the rail, such a known vehicle would be blocked and no longer capable of proceeding, whereby it would be necessary to intervene manually to remove the vehicle from the railway and place it again between the railway beyond the obstacle. Especially in sections where there are numerous and frequent obstacles, a vehicle according to the prior art becomes practically unusable.

Since such known bogies take advantage of the internal stem, i.e., the side of the rail that is vertically turned to exert the driving action, avoiding proceeding on the upper crown of the rail where the railway convoys instead travel, it is not uncommon for the presence of an obstacle along the rail to affect only the stem or side, leaving the surface of the crown free. In such a condition, therefore, the railway convoy is not prevented from proceeding while the bogie would be blocked by the presence of the obstacle.

Sometimes, however, the obstacles present along the track can affect the entire area of the rail, making it unusable both at the level of its inner stem and at the level of the upper crown surface of the rail.

The need is therefore felt to allow a bogie for inspection and/or maintenance of the underframe of a railway vehicle to overcome any obstacles present along the railway and in particular on the inner side or inner stem of the rails of the railway.

### SUMMARY OF THE INVENTION

The object of the present invention is therefore to propose a solution that meets the needs complained of with reference to the prior art

This and other objects are achieved with an assembly according to claim 1, as well as with a method according to claim 10.

Some advantageous embodiments are the object of the dependent claims.

According to an aspect of the invention, an assembly comprises a bogie for inspection and/or maintenance of an underframe of a railway convoy, said bogie being of the type suitable for moving on a railway having two rails placed side-by-side and a space therebetween, and at least one rolling guide, suitable for being arranged in the space between the side-by-side rails.

Said bogie comprises a frame, and a plurality of wheel groups mounted to the frame and at least one transverse motion device operatively connected with the wheel groups of said plurality to move the wheel groups of said plurality transversally in retraction and/or extraction.

The bogie further comprises one or more auxiliary bearings mounted to the frame to face the space between the side-by-side rails.

The at least one rolling guide of the assembly acts as a lower rolling support for said one or more auxiliary bearings.

The assembly further advantageously comprises an electronic control system to control the activation of the at least one transverse motion device based on information acquired on the presence and/or location of the at least one rolling guide.

One or more sensors can be provided for detecting information on the presence of the at least one rolling guide in the space between the side-by-side rails, said one or more sensors being in operative coupling with the electronic control system for coordinating the operation of the transverse motion device with the information on the presence of the at least one rolling guide detected by the one or more sensors.

In accordance with an embodiment, the electronic control system, by controlling the transverse motion device, is configured to coordinate the extraction of a first set of wheel groups of said plurality with the retraction of a second set of wheel groups of said plurality that excludes the wheel groups of said first group.

The auxiliary bearings can be movable within a retracted raised position and an extracted lowered rolling contact position on the rolling guide and for this purpose a vertical movement device of the one or more auxiliary bearings can be provided in operative coupling with the electronic control system.

Preferably, the at least one rolling guide comprises a level adjustment device for adjusting the level of an underlying lower rolling surface, wherein, preferably, said adjustment device comprises a plurality of adjustable feet, for example each comprising a jack and/or an adjustment screw or grub screw.

The at least one rolling guide is formed by a plurality of modular units each comprising at least one element connecting to an adjacent modular unit comprising at least one lower rolling surface.

According to an aspect of the invention, a method for inspection and/or maintenance of a railway convoy envisages overcoming of one or more obstacles present on a railway having two side-by-side rails comprising the steps of: (i) providing a bogie for inspection and/or maintenance of the railway convoy having a plurality of wheel groups movable between a retracted position in which they are out of contact with the respective rail and an extracted position in which they are in rolling contact with the respective rail, and one or more auxiliary bearings; (ii) approaching an obstacle of said one or more obstacles with at least one wheel group of said plurality; (iii) transversally retracting said at least one wheel group in approach to the obstacle; (iv) bringing one or more auxiliary bearings in contact with an underlying lower rolling surface provided in the space between the side-by-side rails; and (v) advancing the bogie past the obstacle.

The contact step can comprise lowering the auxiliary bearings. Alternatively or in combination, the contact step can comprise adjusting the level of the lower rolling surface of the guide to be at the level of the auxiliary bearings when in operating conditions.

In accordance with an embodiment, the method further comprises laying in the space between the rails at least one rolling guide comprising said lower rolling surface acting as a lower rolling support in the space between the rails for said one or more auxiliary bearings.

In accordance with an embodiment, the method further comprises arranging the lower rolling surface of said at least one rolling guide at a predetermined known level that allows the side-by-side wheel groups to remain at the level of the rail stem.

In accordance with an embodiment, the method further comprises adjusting the vertical level of the lower rolling surface of said at least one rolling guide.

In accordance with an embodiment, the method further comprises the step of transversally retracting a pair of wheel groups to be subjected to one or more controls including: controlling the presence and/or location of the rolling guide in the space between the rails.

### BRIEF DESCRIPTION OF THE DRAWINGS

Further features and advantages of the invention will appear from the following description of embodiments, given by way of non-limiting example, with reference to the accompanying figures, in which:

FIG. 1 is an axonometric bottom view of a bogie, according to an embodiment;

FIG. 2 A is an axonometric view showing a portion of a bogie with two wheel groups, according to an embodiment;

FIG. 2 B is a cross-sectional view of a wheel group of a bogie, according to an embodiment, when in operating conditions;

FIGS. 3 and 4 are respectively an axonometric view and a top plan view showing an assembly, according to an embodiment, in which a bogie is shown wherein some parts are omitted for clarity, and a guide laid in the space between the rails;

FIG. 5 is a raised vertical view of a bogie, according to an embodiment;

FIG. 6 is an axonometric view of a guide, according to an embodiment, laid in the space between the rails;

FIG. 7 is a raised vertical view of a portion of an assembly in which a bogie, according to an embodiment in which some parts are omitted for clarity, is shown in rolling support on a guide;

FIG. 8 shows the detail indicated with the arrow VIII of FIG. 7;

FIG. 9 is a schematic raised vertical view of an assembly in which a bogie, according to an embodiment, is in rolling support on a guide;

FIG. 10 shows some possible steps of a method, in accordance with an embodiment;

FIG. 11 is a flow chart illustrating some possible steps of a method, according to an embodiment;

FIG. 12 is a block diagram schematically showing a synchronizing device, according to an embodiment.

### DESCRIPTION OF THE PREFERRED EMBODIMENTS

In accordance with a general embodiment, an assembly 10 is provided comprising a bogie 1 for inspection and/or maintenance of an underframe of a railway convoy. Said bogie 1 is of the type suitable for moving on a railway B. The railway B has two side-by-side rails R1, R2 and a space S therebetween.

Said space S can be delimited below by the provision of sleepers between the rails R1, R2. Each rail R1 or R2 of said two side-by-side rails has an inner side or stem G thereof facing the inner side or stem G of the other rail R2 or R21. The profile of the rail in cross-section forms an upper surface for the rolling of the conical wheels of the convex railway convoy, called rail crown F. Below the stem B, a foot of the rail can be provided which defines a lower fence plane P of the rail.

The bogie 1 comprises a frame 2. The frame 2 can have a generally box-like body and can comprise longitudinal beams and transverse beams to form a platform. The frame 2 preferably has a transverse extension T2 thereof and a longitudinal extension L2 thereof. The transverse extension of the frame 2 of the bogie 1 is preferably less than the transverse distance between the rails R1, R2 placed side-by-side of the railway B, and in particular of the distance between the stems G of the rails facing one another. Longitudinally, the frame 2 extends for a longitudinal extension L thereof, i.e., in the extension direction of the railway B, i.e., in the direction of travel X of the bogie 1 along the railway B.

The bogie 1 further comprises a plurality of wheel groups 31, 32, 33, 34. Some wheel groups of said plurality can be mounted to the frame 2 longitudinally spaced from one another. In accordance with a preferred embodiment, the bogie 1 comprises four wheel groups arranged in pairs placed side-by-side with one another, forming two pairs of opposite wheel groups 31-32, 33-34 longitudinally spaced from one another along the longitudinal extension of the frame 2.

At least some wheel groups of said plurality can comprise two wheels each, and in particular a first wheel with vertical axis for rolling on the inner stem G of the rail and a second sub-horizontal-axis stabilizing wheel for rolling on the lower fence plane P of the rail R1, R2. The vertical axis wheel can be a driving wheel 3 or a traction wheel 3 thereby forming a traction wheel group. A wheel group can further comprise a support wheel.

At least some wheel groups can comprise two wheels with an elastic preloading device 36 therebetween for biasing a wheel, for example a driving wheel 3 with vertical axis, against the respective rail R1, R2. For example, the elastic device 36 can be provided between a stabilizing driven wheel and the driving wheel 3 to influence the driving wheel against the stem G of the rail R1, R2. In accordance with an embodiment, all the wheel groups of the bogie comprise at least one driving wheel 3.

In accordance with an embodiment, at least some wheel groups comprise tracked wheels, i.e., which form a continuous tracked unit.

Advantageously, the wheel groups 31, 32, 33, 34 of said plurality are movable with respect to the frame 2 between a retracted position in which they are out of contact with the respective rail R1, R2 and an extracted position in which they are in rolling contact with the respective rail R1, R2. Preferably when in the retracted position, said wheel groups are inside the transverse footprint of the frame 2 and when in the extracted position they project transversally outwards from the frame 2.

The bogie 1 comprises at least one transverse motion device 4, operatively connected with the wheel groups of said plurality, for moving in transverse extraction and/or retraction with respect to the frame the wheel groups mounted to the frame longitudinally spaced from one another.

In accordance with an embodiment, as shown for example in FIG. 2a, the at least one transverse motion device 4 comprises at least one linear actuator mounted between the frame 2 and at least one wheel group 31, 32, 33, 34 of said plurality. The at least one linear actuator can be a hydraulic and/or pneumatic and/or electromechanical actuator. In accordance with an embodiment, the transverse motion device 4 comprises a telescopically extendable device comprising a hollow cylinder and a telescopically extendable element, for example a piston, operable under the control of an electronic control device 6.

Preferably, a transverse motion device 4 is provided for each pair of side-by-side wheel groups 31-32, 33-34 and transversally opposite with respect to the frame 2. Preferably, the action of retraction and/or extraction on a pair of side-by-side and transversally opposite wheel groups is coordinated (for example it is simultaneous) by means of the respective transverse motion device 4 operatively connected to said pair and controlled by an electronic control system 6.

The frame 2 can comprise windows 24 for accommodating the transverse movement of the wheel groups 31, 32, 33, 34.

Advantageously, the bogie 1 also comprises one or more auxiliary bearings 7 mounted to the frame 2 and facing the space S between the rails R1, R2.

In accordance with an embodiment, the auxiliary bearings 7 are movable between a lowered extracted rolling position and a raised retracted resting position and the bogie 1 comprises a vertical movement device (not shown) operatively connected with the auxiliary bearings 7 of said plurality to move said auxiliary bearings 7 in extraction and/or retraction.

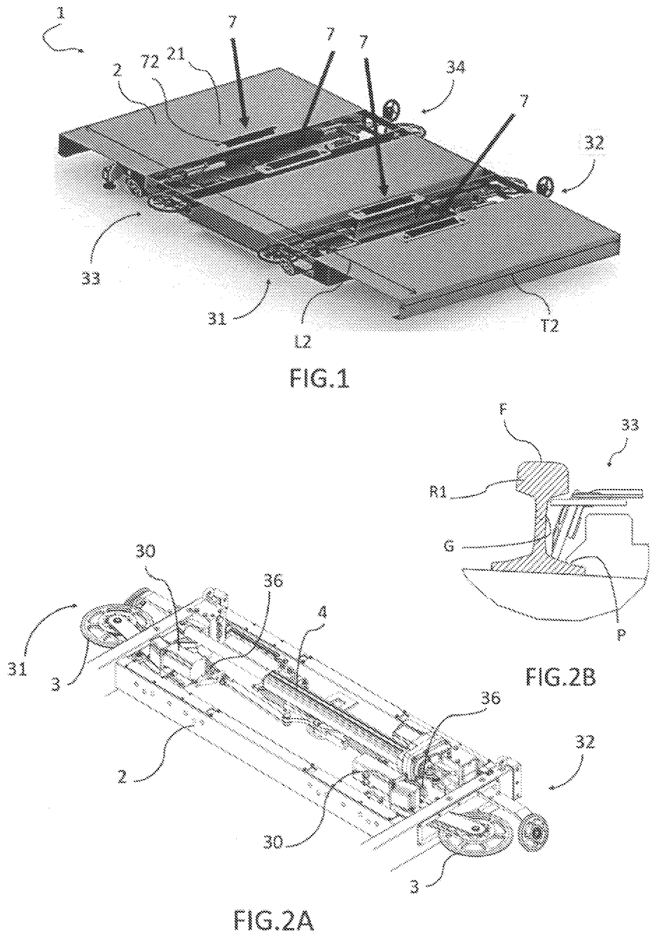

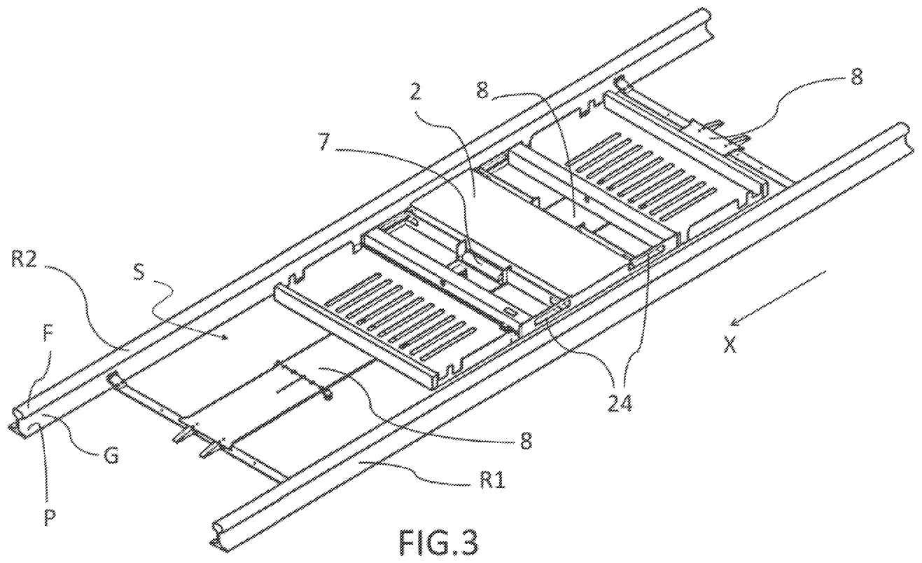

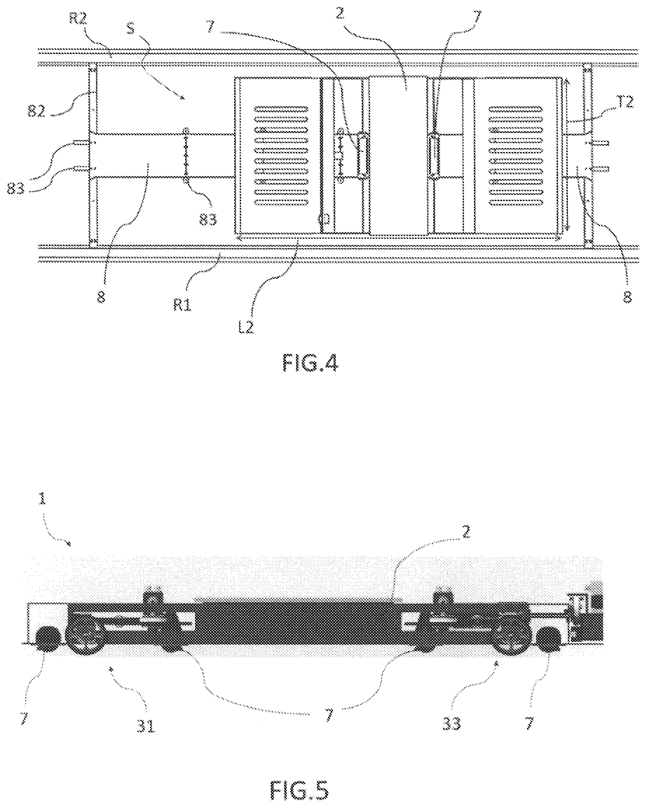

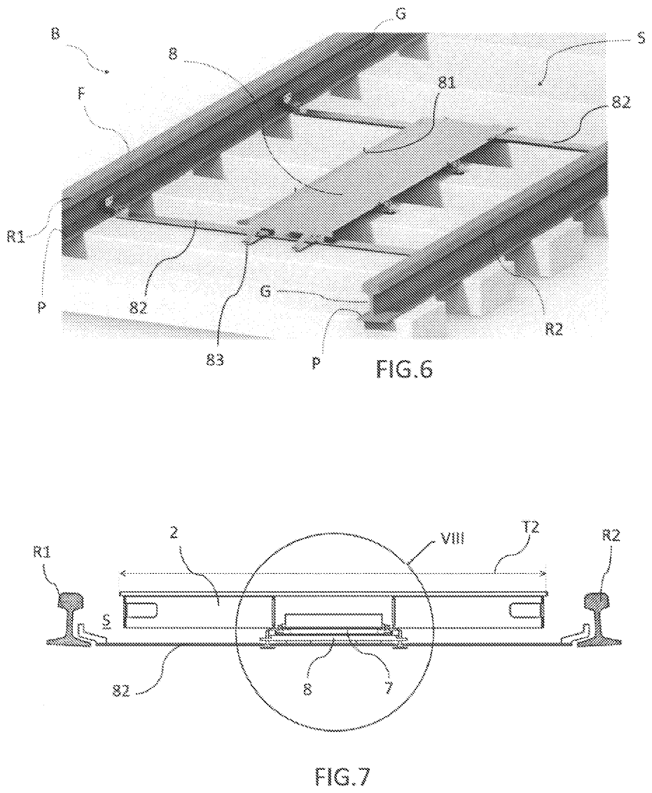

As shown for example in FIG. 1, in accordance with an embodiment, the one or more auxiliary bearings 7 face openings 72 from the lower face 21 of the frame 2, i.e., the face 21 facing the space S between the rails R1, R2 when in operating conditions.

With further advantage, the assembly 10 further comprises at least one rolling guide 8 (or guide 8) comprising a lower rolling surface 9 which forms a lower support for rolling the one or more auxiliary bearings 7.

When in operating conditions, said at least one rolling guide 8 is laid in the space S between the rails R1, R2, acting as a lower rolling support for said one or more auxiliary bearings 7 of the bogie 1. The rolling guide 8 preferably comprises an elongated rigid body. The rolling guide 8 is preferably suitable for stable support on the sleepers between the side-by-side rails of the railway. For example, the rolling guide 8 comprises at least one elongated rigid track and/or at least one inclined ramp, i.e., on a slope.

It is thereby possible to overcome one or more obstacles present on at least one rail R1, R2 of the railway B. In particular, thanks to such a bogie 1 it is possible to overcome obstacles affecting the stem and/or the lower fence plane of the rail.

In accordance with an embodiment in which the auxiliary bearings 7 are movable, said electronic control system 6 is in operative coupling both with the transverse motion device 4 and with the vertical movement device, to coordinate the extraction of at least some of the one or more auxiliary bearings 7 with the retraction of at least some wheel groups 31, 32, 33, 34 of said plurality.

The electronic control system 6 can be located at least partially on the bogie 1, for example on the frame 2. A portion of the synchronizing device can be arranged in remote operative coupling and for example a wireless antenna is mounted to the frame 2 of the bogie.

In accordance with a preferred embodiment, the one or more auxiliary bearings 7 comprise one or more rollers 7, preferably rollers 7 arranged with a horizontal axis directed transversally with respect to the direction of travel X of the bogie 1. For example, four wheel groups 31, 32, 33, 34 and four auxiliary rollers 7 can be provided.

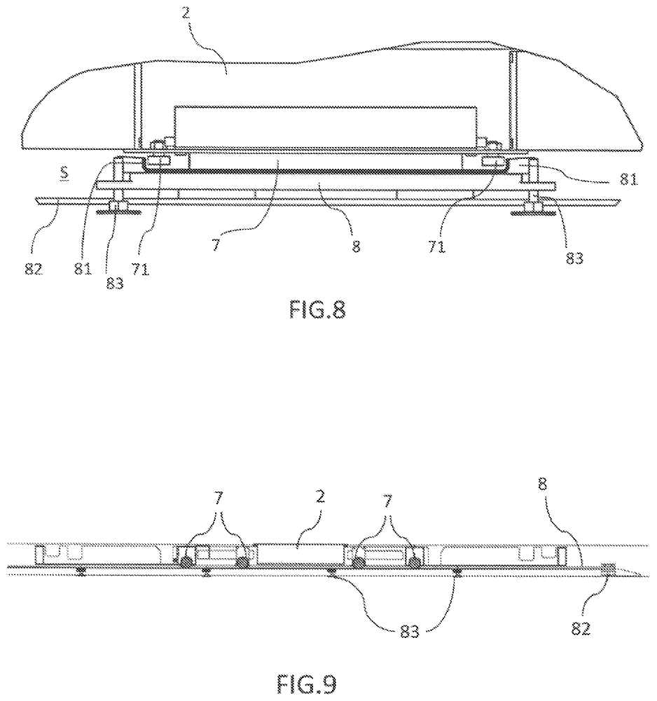

As shown for example in FIG. 8, the one or more auxiliary bearings can further comprise one or more stabilizing wheels 71 with a vertical axis and suitable for rolling against a vertical rolling abutment 81 of the rolling guide 8, for example formed by the provision of a protrusion in the body of the guide 8 and/or a groove in the body of the guide 8.

The rolling guide 8 can comprise a railway support structure comprising transverse support elements 82 supporting the rolling guide 8 in position and/or support feet 83 for the rolling guide. For example, the support feet 83 are provided between a transverse element and the rolling guide. Preferably, an adjustment device is provided for adjusting the arrangement of the rigid rolling guide, for example by vertically adjusting the support feet 83 by providing an adjustment screw and/or a jack in at least some, but also all, of the support feet 83. The support feet 83 can comprise an elastic element for substantially vertically biasing the rolling guide 8. At the entrance of the rolling guide 8, a transversally tapered lead-in portion 84 can be provided.

The rolling guide 8 can be formed by a plurality of segments which for example form modular units connectable to one another in succession. Each modular unit or segment of the rolling guide can comprise linking elements to an adjacent modular unit, such as interlocks and/or undercut hooks.

The bogie 1 preferably comprises a housing site, for example a receptacle provided in or on the frame 2, for housing in a transport configuration said at least one rolling guide 8 acting as a lower rolling support for said one or more auxiliary bearings 7. When in transport configuration, the rolling guide 8 can be disassembled, i.e., it can be composed of separate parts that are assembled on the railway B or during the laying of the guide 8 on the railway B. In accordance with an embodiment, the receptacle for housing the rolling guide is placed in a transversally median portion of the bogie frame.

In accordance with an embodiment, the bogie 1 further comprises a laying device for laying (not shown) said at least one rolling guide 8, in the space S between the rails R1, R2 flanked by the railway B. For example, said device for laying the guide comprises launching elements for example comprising rolling thrust elements for laying the sliding guide 8 in the space S between the rails R1, R2. For example, the laying device comprises an articulated robotic arm comprising an operative portion adapted to fix the rolling guide 8 in place, for example on said transverse support elements 82 and/or adapted to adjust the feet 83.

In accordance with an embodiment, the laying device of the at least one rolling guide 8 is in coordinated relation to the vertical movement device of the auxiliary bearings 7, where provided. In accordance with a preferred embodiment, the bogie 1 further comprises at least one layout sensor (not shown) to detect information on the level of the frame with respect to the rails and/or on the layout of the frame, said at least one layout sensor being in operative coupling with the vertical movement device of the one or more auxiliary bearings 7 to adjust the amount of extraction of the auxiliary bearings 7 to maintain the level of the frame with respect to the rails and/or the layout of the frame substantially constant.

Preferably, one or more sensors are provided for detecting information on the presence and/or location of the at least one rolling guide 8 in the space S between the side-by-side rails, said one or more sensors being in operative coupling with the electronic control system 6 for coordinating the operation of the transverse motion device 4 of the wheel groups with the information on the presence of the at least one rolling guide 8 detected by the one or more sensors.

In accordance with a preferred embodiment, the synchronizing device 6, for example an electronic control device, is configured to determine that the one or more auxiliary bearings 7 are in rolling contact with the at least one rolling guide 8 and that simultaneously at least some, but also all of the groups 31, 32, 33, 34 of said plurality are in retracted position.

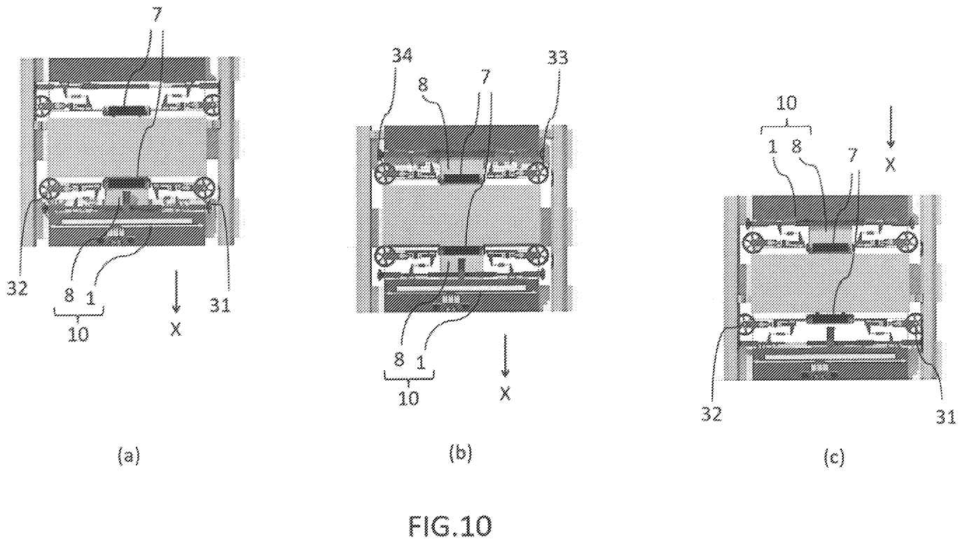

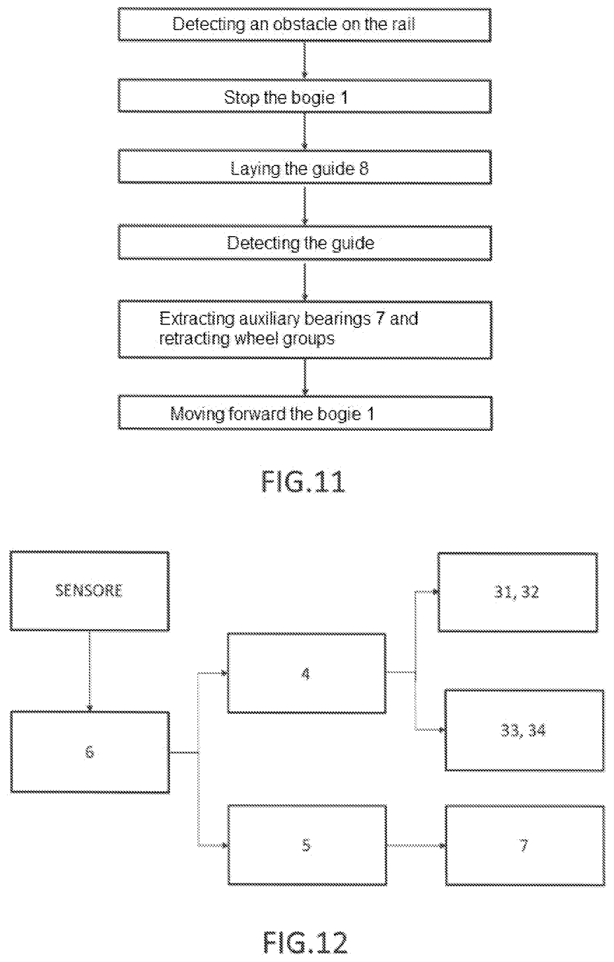

When in operating conditions, as shown for example in FIG. 10, a bogie 1 approaching an obstacle (not shown) proceeds (a) retracting the front wheel groups 31, 32 in approach to the obstacle and bringing the auxiliary bearings 7 in rolling support on the previously laid guide 8; the bogie 1 then advances in support on the rear wheel groups 33, 34 and on at least one roller 7, until the rear wheel groups 33, 34 approach the obstacle; at this point the rear wheel groups 33, 34 are retracted; then the bogie 1 can advance on the rollers 7 avoiding obstacles provided near the rails R1, R2 and for example of the stem G and/or of the lower fence plane P of the rail R1, R2.

Hereinafter, a method for inspection and/or maintenance of a railway convoy which envisages overcoming one or more obstacles will be described.

The method comprises the step of providing a bogie 1 for inspection and/or maintenance of the railway convoy having a plurality of wheel groups movable between a retracted position in which they are out of contact with the respective rail and an extracted position in which they are in rolling contact with the respective rail, and one or more auxiliary bearings facing the space between the rails.

The bogie is preferably a bogie 1 in accordance with any of the previously described embodiments.

The method comprises the step of approaching an obstacle of said one or more obstacles with at least one wheel group of said plurality.

The method further comprises, at this point, the step of transversally retracting said at least one wheel group in approach to the obstacle and bringing one or more auxiliary bearings 7 into the space S between the side-by-side rails in contact with an underlying lower rolling surface 9, such as a lower rolling surface 9 facing upwards of a rolling guide 8 according to any of the previously described embodiments.

The step of transversally retracting a pair of wheel groups 31, 32 can be subjected to one or more controls including: checking the presence and/or the location of the rolling guide 8 in the space between the rails.

Preferably, the method further comprises advancing the bogie along the railway, overcoming the obstacle.

After the step of approaching and prior to the step of retracting, the method can comprise the step of stopping the bogie under stationary conditions.

In accordance with an embodiment, the method further comprises the step of laying at least one rolling guide 8 in the space S between the rails of the railway, next to one or more obstacles present on the railway and particularly near the inner stem G of the railway and/or the lower fence plane P of the railway. This laying step can comprise laying a plurality of parts that jointly form said rolling guide 8 and assembling the plurality of parts during the laying process or after laying on the railway.

The laying step can comprise adjusting the arrangement of the rolling guide 8.

The assembling step can be performed automatically by providing a series of predetermined instructions stored in operative coupling with said electronic control system 6.

The method can comprise the step of arranging the lower rolling surface 9 of said at least one rolling guide 8 at a predetermined known level allowing the side-by-side wheel groups 31, 32, 33, 34 to remain at the level of the rail stem. This avoids having to raise and/or lower the bogie 1 during the transition between resting exclusively on wheel groups and resting on auxiliary bearings 7.

The method can comprise the step of adjusting the vertical level of the lower rolling surface 9 of said at least one rolling guide 8, for example by height adjustment of adjustable feet 83 of the guide 8.

As can be seen, by virtue of the characteristics described above provided disjointly or jointly with one another in particular embodiments, it is possible to meet the needs lamented above, obtaining the aforementioned advantages, and in particular:
the rolling guide can be placed centrally between the rails and allows the bogie to remain centred and at the right height, allowing it to resume movement on the wheel groups once the obstacle has been overcome;
the guide is a component that can be quickly assembled disassembled on the railway with a pressure coupling system without having to make infrastructural changes to the railway and without damaging it;
the same linear motors that extract and retract the wheelsets (or wheel groups) mounted during installation on the tracks, can also extract or retract the wheelsets (auxiliary bearings) mounted near the rolling guide to overcome obstacles and thus allow the transition from movement on wheels to movement on rollers;
it is clearly understood that the auxiliary bearings can be mounted fixed, i.e., not lowerable, with respect to the bogie frame;
the bogie can be provided equipped with the necessary sensors (for example, an inductive/magnetic proximity sensor or an electric lever contact that closes/opens when the bogie enters the guide) to detect the presence of the guide and start the operations necessary to be able to advance thereon, i.e., controlled retraction of the wheel groups;
the guide can consist of modular components so that guides of different lengths can be produced simply by adding or removing modules, depending on the obstacle to be overcome;
for example, a kit for the construction of two rolling guides with a length belonging to the range of 1.5 m to 2.7 m is provided.
it allows to overcome axle counters, larger line conductors, screw connections to the rail core for the electrical continuity of the rails, screw connections for the connection of two sections of rails;
potentially, the obstacle that can be overcome with this solution has no length limits, because the sliding guide 8 can potentially be extended by an indefinite amount;
furthermore, where the at least rolling guide is inclined forming an ascending ramp and a descending ramp, which can be installed near the operating paths, so that the bogie, with its auxiliary bearings (rollers), can roll on the operating paths and descend to return to the guide, in this case the ramps could be left on the track, as they would not obstruct the passage of the train;
the extraction and retraction operations required to overcome an obstacle can take about one minute per obstacle.

It is understood, however, that the foregoing is of exemplary and non-limiting value, therefore any variations of detail which may become necessary for technical and/or functional reasons, are considered from now on to fall within the same protective scope defined by the following claims.

1.-12. (canceled)

13. An assembly, comprising:
a bogie for inspection or maintenance of an underframe of a rail convoy, the bogie being of the type suitable to move on a railway with two rails placed side-by-side and a space therebetween; and
at least one rolling guide suitable for being placed within the space between the side-by-side rails;
wherein the bogie comprises:
a frame;
a plurality of wheel groups, mounted to the frame and transversally movable between a retracted position in which the wheel groups are out from contact with the respective rail and an extracted position in which the wheel groups are in contact with the respective rail;
at least one transverse motion device operatively coupled with the plurality of wheel groups to transversally move in retraction or extraction the plurality of wheel groups; and
one or more auxiliary bearings mounted to the frame to face the space between the side-by-side rails;
wherein the at least one rolling guide acts as a lower rolling support for the one or more auxiliary bearings.

14. The assembly according to claim 13, further comprising an electronic control system to control the activation of the at least one transverse motion device based on information acquired on a presence or location of the at least one rolling guide.

15. The assembly according to claim 13, wherein the one or more auxiliary bearings comprise one or more rollers, wherein an axis of rotation of the one or more auxiliary bearings is substantially horizontal and directed transversally to a forward direction of the bogie.

16. The assembly according to claim 15, wherein the at least one rolling guide acts as a lower rolling support for the one or more auxiliary bearings and comprises a rigid track or a rigid slope ramp.

17. The assembly according to claim 16, comprising one or more sensors to detect information on the presence of the at least one rolling guide within the space between the side-by-side rails, the one or more sensors being operatively coupled with the electronic control system to coordinate activation of the transverse motion device with information on the presence of the at least one rolling guide detected by the one or more sensors; or
wherein the electronic control system, by means of control of the transverse motion device, is configured to coordinate extraction of a first set of wheel groups with retraction of a second set of wheel groups that excludes the wheel groups of the first set.

18. The assembly according to claim 17, wherein the bogie further comprises a housing to house, in a transport configuration, the at least one rolling guide, wherein the housing belongs to the frame of the bogie, located in a transversally mid portion of the frame of the bogie; and wherein, the bogie further comprises a launch device for launching, within the space between the side-by-side rails of the railway, the at least one rolling guide.

19. The assembly according to claim 18, wherein the at least one rolling guide comprises a level adjustment device to adjust a height of a lower rolling surface.

20. The assembly according to claim 19, wherein the one or more auxiliary bearings comprise one or more stabilizing wheels with a vertical axis and suitable for rolling against a vertical rolling wall of the rolling guide.

21. The assembly according to claim 20, wherein the one or more auxiliary bearings of the bogie are movable within the space between rails between a rolling lowered position and a lifted resting position, wherein the bogie further comprises a vertical motion device operatively coupled with the plurality of auxiliary bearings to move in extraction or retraction of the auxiliary bearings, wherein the electronic control system is operatively coupled with both a transverse motion device and the vertical motion device to coordinate the extraction of at least some of the one or more auxiliary bearings with the retraction of at least some of the plurality of wheel groups to overcome one or more obstacles on at least one rail of the railway.

22. The assembly according to claim 21, wherein the at least one rolling guide is formed by a plurality of modular units, each comprising at least one connecting element to an adjacent modular unit comprising at least one lower rolling surface, wherein at the end of the rolling guide, it is provided with an inlet portion that is transversally tapered.

23. A method for inspection or maintenance of a rail convoy that overcomes one or more obstacles on a railway with two rails placed side-by-side, comprising the steps of:
providing a bogie for inspection or maintenance of the rail convoy having:
a plurality of wheel groups movable between a retracted position in which the wheel groups are out from contact with the respective rail and an extracted position in which the wheel groups are in contact with the respective rail, and one or more auxiliary bearings;
approaching an obstacle of the one or more obstacles with at least one wheel group of the plurality;
transversally retracting the at least one wheel group approaching the obstacle;
bringing the one or more bearings in contact with an underlying lower rolling surface located within a space between the two rails placed side-by-side; and
moving forward the bogie, thereby overcoming the obstacle.

24. The method according to claim 23, further comprising the steps of:
launching. within the space between the two rails placed side-by-side, at least one rolling guide comprising the lower rolling surface that acts as a lower rolling support for the one or more auxiliary bearings within the space between the two rails placed side-by-side; or
arranging the lower rolling surface of the at least one rolling guide at a predetermined known level that allows wheel groups placed side-by-side to be at a level of a web of the rail; or
adjusting a height of the lower rolling surface of the at least one rolling guide; or
transversally retracting a pair of wheel groups is subject to one or more checks including controlling a presence or a location of the rolling guide within the space between the rails.
